(19) United States
(12) Patent Application Publication
(10) Pub. No.: US 2009/0169073 A1
(43) Pub. Date: Jul. 2, 2009

(54) COMPUTER IMPLEMENTED METHOD AND SYSTEM FOR PROCESSING IMAGES

(75) Inventors: Romain Xavier Areste, Milwaukee, WI (US); Gopal Biligeri Avinash, Menomonee Falls, WI (US); Renuka Uppaluri, Pewaukee, WI (US); Kadri Nizar Jabri, Waukesha, WI (US); Gireesha C. Rao, Pewaukee, WI (US); Yogesh Srinivas, Hartland, WI (US)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 11/968,270

(22) Filed: Jan. 2, 2008

(51) Int. Cl. G06K 9/00

(52) U.S. Cl. 382/128

(57) ABSTRACT

A computer implemented method and system modifying image processing parameters based on user feedback are disclosed herein. The method comprises: obtaining user preferences on a set of displayed images, based on user feedback on a plurality of queries related to at least one domain-specific descriptor and a plurality of corresponding response options indicating a change in at least one image attribute. The set of displayed images are processed by a known set of image processing parameters. The plurality of corresponding response options are being selectable by a user as user preference in response to the plurality of queries. The method further includes translating the changes in the image attributes to a modified set of image processing parameters.

### FIELD OF THE INVENTION

The present invention relates generally to image processing and more particularly, this invention relate to a computer implemented method for modifying image processing parameters based on user feedback.

### BACKGROUND OF THE INVENTION

Images captured by different techniques or devices need to be displayed to an end user in a required format. For example, medical images need to be displayed based on the choice of the radiographer or the physician who analyzes the images. Modern digital imaging equipments have the capability to offer different representations of an image. Hence after the acquisition, different ways are used to present the data to the end user. The representation of the images can be controlled via an image processor through different image processing parameters. However the image quality being a very subjective appreciation with lots of variation among end users, each needs its own customization of the image-processing parameters. Customizations process is generally long and translation of the end user's wish can be inaccurate which extends the process even more. Besides the time involved in the customization process, the end user may not be able to use the imaging device until the final parameters are defined.

Further many times the customization is performed with the help of an expert such as a radiographer and this requires the expert visiting the imaging station or the place where the images are available, very frequently. Also the quality of the images will depend on the efficiency of the technician or engineer who modifies the image processing parameters analyzer's or expert's requirements and also on the expert's ability to express his requirement correctly to the technician. So the expertise of technician and the analyzer is very critical and they need to be present at the same time at the same location to fine-tune the images for achieving the desired image quality.

Thus today customizing an imaging system is time consuming and cumbersome as the human intervention is more and is very critical in defining the quality of the images. There exist different methods to enhance the quality of the images. Images are displayed to an expert for collecting his feedback on the images and based on the feedback the image processing parameters are modified. The images are reprocessed using the modified parameters and send to the expert for review. So the expert needs to visit the imaging station again to review the images and the process continues till the expert is satisfied.

There are different image processing software applications for home PCs that allow images to be modified, for example, by adjusting the sharpness, brightness, or color saturation. Some of the solutions suggest providing an expert system to enhance the images. But these expert systems generally provides a different set of images processed using different image processing parameters and then the user is prompted to select one image of his choice from the plurality of images. Unfortunately, these programs are difficult for inexperienced users. Such users often do not understand these technical terms, or the adjustments that are possible. As a result, they are either not able to obtain the types of images they prefer, or alternatively, must complete a tiresome trial-and-error process using various settings before they arrive at settings which they prefer.

Therefore a new approach needs to be designed to allow real-time modification of the image processing parameters and to reduce the dependency on the skills of the person customizing via the use of a preference-driven methodology.

### SUMMARY OF THE INVENTION

The above-mentioned shortcomings, disadvantages and problems are addressed herein which will be understood by reading and understanding the following specification.

One embodiment of the present invention provides a computer implemented method of modifying image processing parameters based on user feedback. The method comprises: obtaining user preferences on a set of displayed images, the set of displayed images processed by a known set of image processing parameters, based on user feedback on a plurality of queries related to at least one domain-specific descriptor and a plurality of corresponding response options indicating a change in at least one image attribute, the plurality of corresponding response options being selectable by a user as user feedback in response to the plurality of queries; and translating the change in at least one image attribute to modified sets of image processing parameters.

In another embodiment, a computer implemented method of modifying image processing parameters of an imaging system, is provided. The method comprises: presenting a user with at least one processed image for review, wherein the at least one processed image is processed with a set of known image processing parameters; providing the user with a plurality of questions to solicit user feedback on domain-specific descriptors of at least one processed image; obtaining user feedback through a plurality of responses from the user to the plurality of questions; automatically translating the user feedback on domain-specific descriptors to changes in at least one image attribute; converting changes in at least one image attribute to at least one new set of image processing parameters; and processing the at least one processed image using at least one new set of image processing parameters.

In yet another embodiment, a computer implemented method for image processing is disclosed. The method comprises: (a) selecting at least one image from an image processing server connected to a database using an interface; (b) processing the at least one image using an initial set of image processing parameters on the image processing server; (c) presenting the at least one processed image on a remote display for review by a user; (d) obtaining real-time feedback on the reviewed at least one processed image from the user using the interface; (e) modifying the image processing parameters in real-time based on the user's real-time feedback; (f) re-processing the at least one image using the modified set of image processing parameters to obtain at least one modified image; (g) reviewing the at least one modified image on the remote display; and (h) repeating steps (d), (e), (f) and (g) until the user is satisfied with the at least one modified image.

In yet another embodiment, a computer implemented image processing system is disclosed. The system comprises: a display for presenting at least one image to a user for review; a feedback system operably coupled to the display for providing the user with a plurality of queries relating to at least one domain-specific descriptor and a plurality of corresponding response options relating to a change in at least one image attribute; a translator coupled to the feedback system for converting the change in at least one image attribute to modified sets of image processing parameters; and an image processor configured for processing the at least one image with the new set of image processing parameters.

In yet another embodiment, a computer-readable medium having computer executable instructions stored thereon for execution by a processor for performing a method is provided. The method comprises: (a) selecting at least one image from an image processing server connected to a database using an interface; (b) processing the at least one image using an initial set of image processing parameters on the image processing server; (c) presenting the at least one processed image on a remote display for review by a user; (d) obtaining real-time feedback on the reviewed at least one processed image from the user using the interface; (e) modifying the image processing parameters in real-time based on the user's real-time feedback; (f) re-processing the at least one image using the modified set of image processing parameters to obtain at least one modified image; (g) reviewing the at least one modified image on the remote display; and (h) repeating steps (d), (e), (f) and (g) until the user is satisfied with the at least one modified image.

Various other features, objects, and advantages of the invention will be made apparent to those skilled in the art from the accompanying drawings and detailed description thereof.

### BRIEF DESCRIPTION OF THE DRAWINGS

FIG. 1 illustrates a flow diagram of an exemplary embodiment of a method of modifying image processing parameters based on user feedback in real time;

FIG. 2 illustrates a flow diagram of an exemplary embodiment of a method of modifying image processing parameters of an imaging system in real time;

FIG. 3 illustrates a flow diagram of an exemplary embodiment of a method of image processing;

FIG. 4 is a block diagram of an image processing system as described in an embodiment of the invention;

FIG. 5 is a flow diagram representing an exemplary embodiment of deriving image processing parameter based on user feedback; and

FIG. 6 is a detailed flow diagram representing an exemplary embodiment of deriving image processing parameters based on the user feedback.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

In various embodiments a method and system for modifying image processing parameters based on user feedback is provided. The user feedback is obtained in real time and a new set of image processing parameters is generated based on the user feedback.

In various embodiments, an expert system is provided for obtaining feedback from user on various domain-specific descriptors of the images. The expert system includes plurality of queries related to at least one domain-specific descriptor and corresponding response options indicating a change in at least one image attribute. The response provided by the user in the form of feedback or the change in at least one image attribute is translated to modified sets of image processing parameter along with its degree, direction or amount of change. The response options are being selectable by a user as his feedback on the domain-specific descriptors. In an example, the cumulative response may be a weighted combination of responses from different queries.

In an embodiment the invention provides a workflow allowing real-time interaction with an imaging chain embedded in a complete imaging system from remote devices. The interactions can be either manual or automatic by using a preference-driven analysis to define the best image processing parameters.

In an embodiment the invention provides a method and system for real time customization of imaging equipment via a remote device.

In an embodiment the invention provides a real time user driven customization of the image processing parameters used in image processing. The image processing parameters are obtained directly from the feedback eliminating the need of manual interpretation or modification of the image processing parameters.

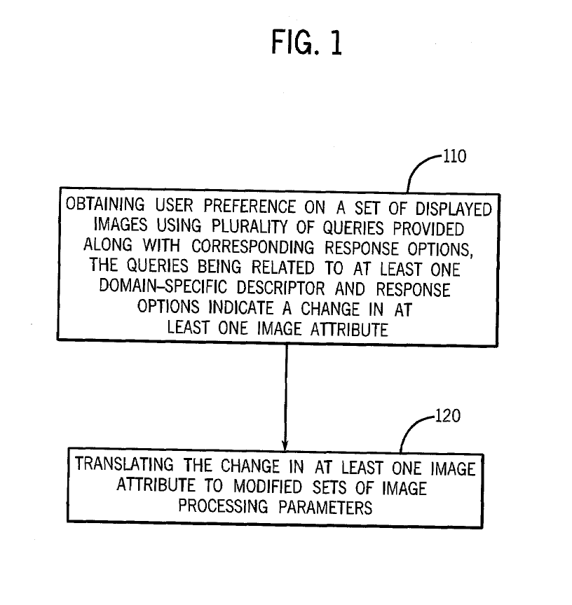

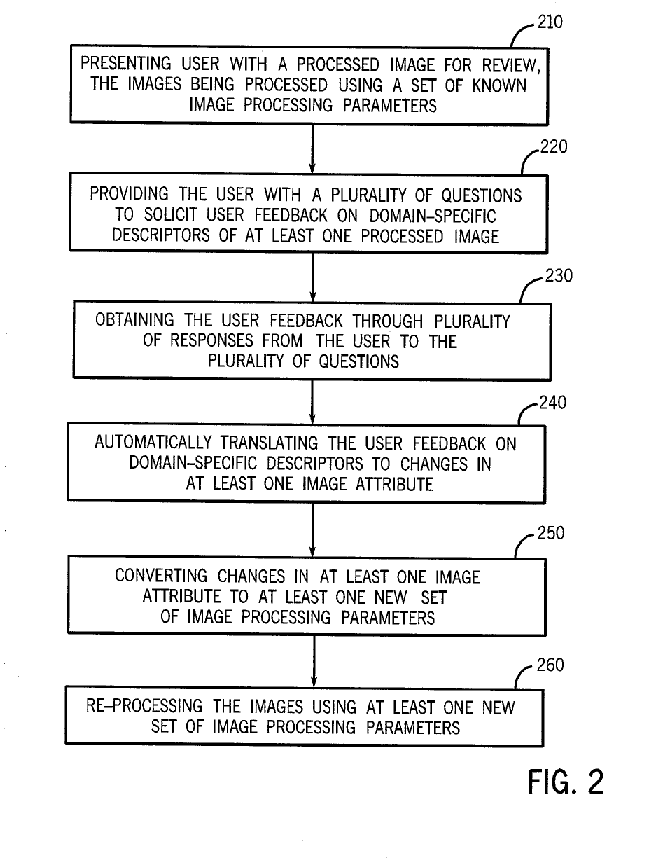

FIG. 1 is a flowchart illustrating a method of modifying image processing parameters based on user feedback in real time as described in an embodiment of the invention. At step 110, user preferences are obtained on a set of displayed images. The displayed images are processed using a known set of image processing parameters. The user preferences are obtained through user feedback on various domain-specific descriptors of the displayed images. In an example, an imaging processor may process the images using a known set of image processing parameter and the processed images may be displayed to the user for analyzing domain-specific descriptors of the image. These images are analyzed by the user and in case of medical images, an expert such as radiologist analyzes the images. The user provides his feedback on the images, specifically on the image attributes of the displayed images. For obtaining the user feedback, the user is provided with a plurality of queries along with corresponding responses. The queries are related to at least one domain-specific descriptor. The domain-specific descriptor is a non-image attribute that could be translated into an image attribute using domain specific knowledge. In an example, the domain-specific descriptor includes anatomical and/or functional attributes in a medical image. Thus each query relates indirectly to at least one image attribute and the corresponding plurality of response options indicates a change in at least one image attribute. In an example, the image attributes includes local and overall contrast, brightness, sharpness, noise, artifacts etc. The queries could be provided along with the corresponding possible response options in the form of multiple-choice answers. The response options are provided such that the options are selectable by the user as his feedback on the images. The response could indicate the direction, degree and amount of change required in at least one image attribute. The user is prompted to select a response option displayed along with the queries and thus providing his feedback on at least the changes in image attributes of the displayed images. At step 120, the changes in at least one image attribute, obtained through the user feedback is translated to modified set of image processing parameters. Thus the user preference obtained in the form of textual feedback is converted to at least one a quantifiable image processing parameter. Various steps involved in the method are illustrated clearly with reference to FIG. 2.

FIG. 2 illustrates a flow diagram of an exemplary embodiment of a method of modifying image processing parameters of an imaging system in real time as described in an embodiment of the invention. At step 210, a user is presented with least one processed image for review. The images may be displayed on an image display. The images are processed with a set of known image processing parameters. In an embodiment, the image processing could be done by an image processor and the image processor may fetch the images from an image database. The user or a requesting device where the images need to be displayed may raise a request whenever customization of the image processing parameters is required. The image processor may process the images and display the same upon receiving the request from the user. The image processor or the image database may be located at a remote distance from the image display.

At step 220, the user is provided with a plurality of questions to solicit user feedback on domain-specific descriptors of at least one processed image. This step further includes providing the user with a plurality of queries related to at least one domain-specific descriptors. In an example, the domain-specific descriptor includes anatomical and/or functional attributes in a medical image. The questions are provided along with corresponding response options and the response options indicate the changes in at least one corresponding image attribute. In an example, the query may be related to domain-specific descriptor such as “Lung marking visibility” or “Skin line visibility”. Further each question can have a plurality of domain-specific descriptors options corresponding to at least one image attribute. The response options are selectable by user to express his feedback. The user expresses his preference or provides his feedback by selecting the response options provided along with the questions. The response may also convey the direction, degree and amount of a change that need to be incorporated in the corresponding image attributes to achieve the desired image enhancement.

At step 230, the user feedback is obtained though the plurality of responses from the user to the plurality of questions. Response to a single query may relate to different domain-specific descriptors. On the contrary, feedback on a domain-specific descriptors may be derived using the responses received for different questions.

At step 240, the domain-specific descriptors are automatically translated to changes in at least one image attribute. The at least one domain-specific descriptor is a non-image attribute that could be translated into an image attribute using domain specific knowledge. The user feedback obtained through the responses expresses at least change in the image attributes desired to enhance the image. The response options are configured to indicate changes in image attributes such as image brightness, edge sharpness etc. Using rule based technique, the domain-specific descriptor can be translated to an image attribute. Each image attribute change corresponds to a direction of change in a value of at least one image processing parameter. Further each image attribute change corresponds to an amount of change in a value of at least one image processing parameter.

At step 250, the changes in the image attributes are converted to at least one new set of image processing parameters. This step further includes using a rule based technique to determine a direction of change in a value of the at least one image processing parameter and using a rule based technique to determine an amount of change in the value of the at least one image processing parameter. Based on the direction and amount of change, a cumulative change in each image processing parameter value is decided. The known image processing parameters are updated with the new set of image processing parameters derived based on the user feedback. In an example, the image processing parameters are provided to the image processor, where the images are processed. In an example the image processor may be located at a distant from the image display.

At step 260, at least one processed image is re-processed using the new set of image processing parameters. The processed images are again displayed upon request and the user analyzes the displayed images and the process continues until the user is satisfied with the image attributes.

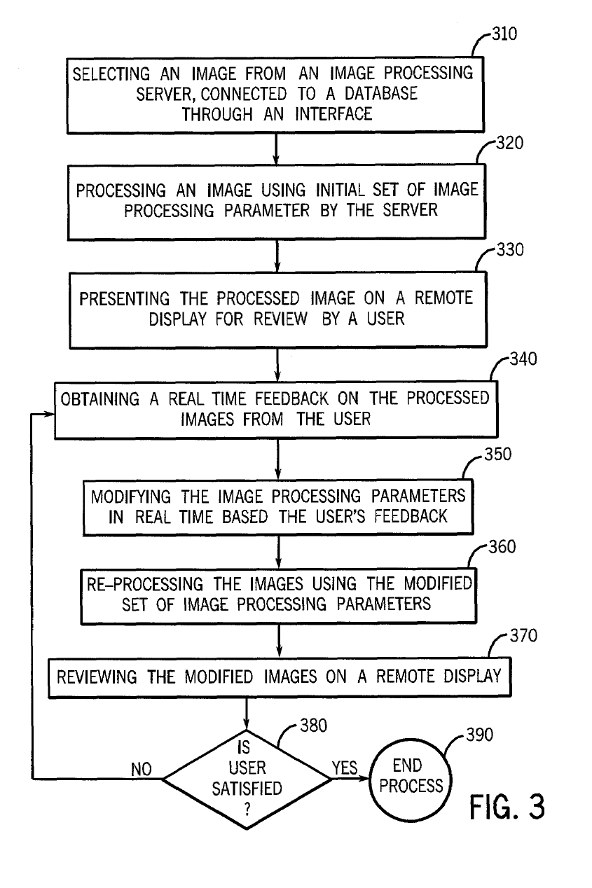

FIG. 3 illustrates a flow diagram of an exemplary embodiment of a method of image processing. At step 310, at least one image is selected from an image processing server. In an embodiment the server may be connected to a database through an interface, where the images can be stored. In an example the image processor may receive a request from a user or from a requesting device requesting to display the images. From the requesting device, remote or not, patients and their related medical images can be queried according to a set of criteria. The query is sent to the distant image-processing server for selecting the images and sending it to the requesting device. The requesting device/module can be a desktop, laptop, PDA or any devices with connectivity capabilities. The server may fetch the images from a database, which could be remotely located, upon receiving the request through an interface. In an embodiment the interface can be remote interface.

At step 320, the selected images are processed with a preferred set of initial image processing parameters by an image processor. The preferred set of initial image processing parameters are known values and could be stored in the image processing server for future reference. In an embodiment upon receiving the request from a user or a requesting device, the image processing server may process the images using the preferred set of initial image processing parameters and send it to the requesting device for display.

At step 330, at least one processed image is displayed on a display for reviewing by the user. In an example, the display is a remote display. In an embodiment, a command from the requesting device may be sent to the image processing server and upon receipt of the request, the image processor may send the images to the display. The display could be in a monitor, PACS station, printers etc. The processed images may be displayed to the user whenever the customization or modifications of image processing parameters are required.

At step 340, a real time feedback is obtained on the displayed images. Generally the feedback is obtained from the user, who is capable of evaluating image attributes of images. In case of medical images the feedback could be obtained from a radiologist, cardiologist, neurologist etc. In an embodiment the user is provided with a plurality of questions to solicit user feedback on at least one domain-specific descriptor of the displays images. This step further includes providing the user with domain-specific descriptor related queries. The queries are provided along with corresponding response options and the response options indicate at least one of the changes in an image attribute including direction of change and the degree of change in the image attributes. The user expresses his preference or provides his feedback by selecting the response options, provided along with the queries. The response may also convey the direction, degree and amount of a change that need to be incorporated in the corresponding image attributes to achieve the desired image enhancement.

At step 350, the image processing parameters are modified in real time based on the user's real time feedback. The modified image processing parameters are obtained based on the user feedback. This is achieved by converting the changes in image attributes obtained from the user response, to a numerical parameter pertaining to a new set of image processing parameters is defined. In an embodiment this could be accomplished manually by a user by manipulating the plurality of image processing parameters using an interface. For example, an application specialist may convert the user feedback to respective image processing parameters. Alternately, the image processing parameters may be derived automatically based on the user feedback. This could be achieved using a rule based or formula based technique to determine the direction of change in value, amount of change in the value of the at least image processing parameter. Based on the direction and amount of change, a cumulative change in each image processing parameter value is decided. The computation of the image processing parameters can combine the results of one or more queries resulting in the use of a set of rules to produce the best results.

At step 360, the images are re-processed using the modified set of parameters and generating a set of modified images. This step might include sending the modified image processing parameters to an image processing server, wherein the images are processed. The initial preferred set of parameters are replaced by the modified image processing parameters. At step 370, the images are sent to the remote requesting device for display. The images are again reviewed on a remote display. The user feedback is obtained and based on that new set of image processing parameters are modified and the images are re-processed and this process continues till the user is satisfied with the image attribute of the displayed images.

Optionally at step 380, the user may be asked whether he is satisfied with the image attributes and if he is satisfied, the process may be stopped as at step 390, and set the modified image processing parameters as the final set of image processing parameter and may be used in customizing the imaging equipment. If the user is not satisfied steps 340-370 might be repeated until the user is satisfied.

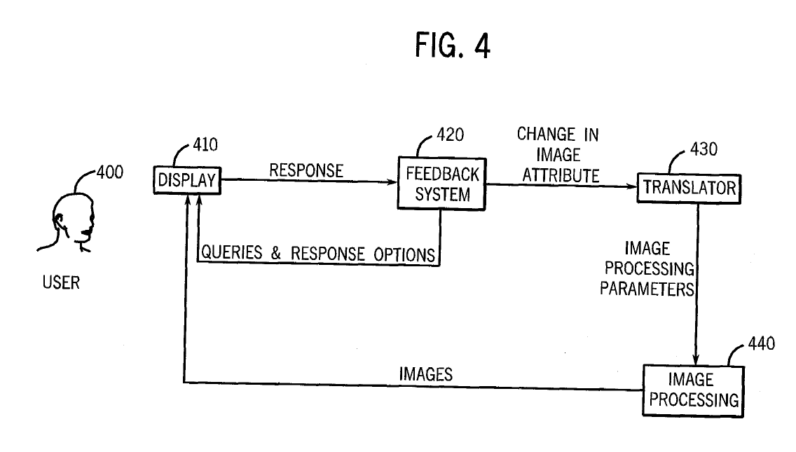

FIG. 4 is a block diagram of an image processing system as described in an embodiment of the invention. A user 400 or radiologist analyzes the images for its image attributes in real time until the images displayed are of desired or expected image quality. For obtaining user's feedback on domain-specific descriptors of the images, the images are displayed on a display 410. In an example the display 410 is configured to be a remote display. This provides remote access to the user from the imaging device, which need to be customized or from the image processor that process the images based on user's feedback or from an application specialist who may derive the image processing parameters based on user's feedback. In an embodiment a feedback system 420 is provided to solicit user's feedback on the at least one domain-specific descriptor of images displayed on the display 410. The feedback system 420 provides a plurality of queries and corresponding responses to the user. The queries and responses pertaining to the displayed images are displayed along with the images on the display 410. The user is prompted to enter their feedback by selecting response options provided along with the queries. The response option given provides an indication about the amount and directions of changes need to be incorporated in the image attributes. The responses provided by the user or the changes in the image attributes are translated to a set of image processing parameter by a translator 430. The translator 430 is configured to receive the changes in image attributes from the user and convert it to a set of modified image processing parameters. In an embodiment the translator 430 may be located as a part of the feedback system 420 or as a part of the image processing server 440. In an embodiment an application specialist may manually interpret the user feedback indicating at least the changes in the image attribute and convert the same to corresponding modified image processing parameters. Once the translator 430 generates the modified image processing parameters, it is sent to the image processing server 440. The image processing server 440 processes the images with the modified image processing parameters and send it to the display for displaying the reprocessed images. The user 400 is provided with the reprocessed images along with queries and is configured to provide his feedback by selecting the responses provided along with the queries. This process is continued until the user 400 is satisfied with the image attributes of the displayed images. Once the user 400 is satisfied, the imaging parameters corresponding to the satisfied images may be set as final image processing parameter and may be used in customizing image processing parameters.

In an exemplary embodiment customization of image processing parameter with the help of PACS system is described. An application specialist and an expert such as radiologist may be available near to the PACS system. Once the customization of an imaging device is required, the PACS system may send a request to an image processing server. The image processing server could be located at a distance. The PACS system and the image-processing server may be connected through a network including wireless or wired network. Once the image processing server receives the request, the image processing server may fetch a set of representative images from a database and processes it with known parameters. The processed images are sent to the PACS system. In an embodiment even the image processing parameters used in processing the images may be sent along with the processed images and may be displayed along with the images. The feedback of radiologists on image attributes is taken by providing plurality of queries, each query relating to at least one domain-specific descriptor. The response option is also displayed along with the queries on the PACS display. The response provided is user interactive and the user can select from the options provided. The response options relate to changes in at least image attribute. Once the user selects the option, the application specialist may derive new set of parameters based on the user feedback. In this event the application specialist is provided with prior information about the image parameters used in processing the displayed image. Based on the same and the user feedback the application specialist may modify the image processing parameters and send it the image processing server. However the PACS system or any associated processor may automatically derive modified image processing parameters based on the user feedback. Once the images are processed with the modified image processing parameters, the images are sent to the PACS display and the process is continued until the user is satisfied. Once the radiologist is satisfied the image processing parameters corresponding the satisfied images are obtained and is used in customizing the imaging device.

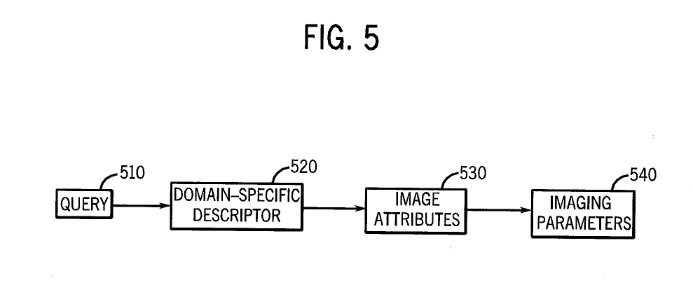

FIG. 5 is a flow diagram representing an exemplary embodiment of deriving image processing parameters based on user feedback. In an embodiment, the user is provided with a set of queries 510 and the queries 510 are related to at least one domain-specific descriptor 520. The queries 510 are provided with the response option and the response option indicate at least change in one image attribute 530. Each query 510 has a plurality of domain-specific descriptors options corresponding to at least one image attribute 530. From the domain-specific descriptor 520 using a rule based technique the image attributes 530 can be derived. The changes in image attributes 530 can be translated to image processing parameters 540. The changes in direction or amount of an image attribute 530 are translated into at least one new set of image processing parameters 540. The direction of change and the amount of change for each image processing parameter value are used to determine a cumulative change in each image processing parameter value.

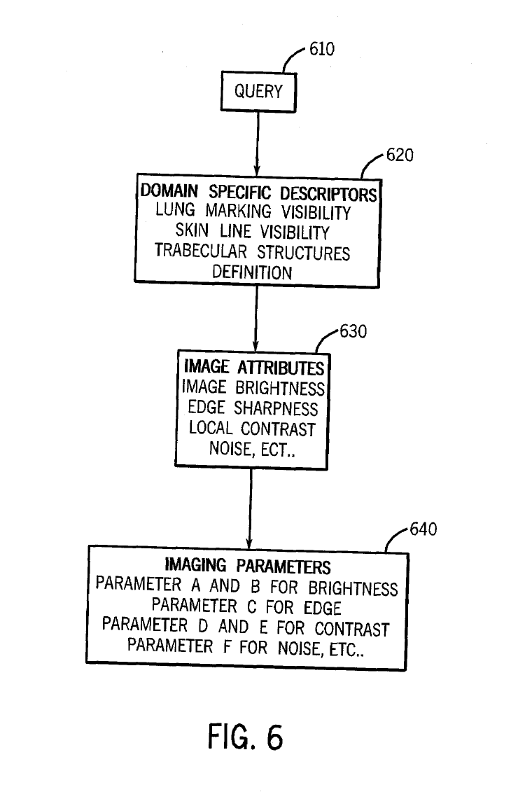

FIG. 6 is a detailed flow diagram representing an exemplary embodiment of deriving image processing parameters described in FIG. 5. The queries 610 are related to at least one domain-specific description 620. The examples of domain-specific description 620 might include lung marking visibility, skin line visibility, Trabecular structures definition etc. The image attributes can be derived using a rule based technique from the domain-specific description 620. The response option could indicate changes in image attributes such as degree or direction of image attributes. The various image attributes might include image brightness, edge sharpness, local contrast, noise etc. From the changes in image attributes 630 a new set of image processing parameters 640 can be derived using a rule based technique. The image processing parameters 640 includes image processing parameter for brightness and contrast, image processing parameter for edge, image parameter for nose etc. Based on the changes in image attributes 630, image processing parameters 640 are derived.

Some of the advantages of the invention include allowing real time customization of an imaging device. This reduces or eliminates the need of multiple review sessions between the application specialist and experts who reviews the images. This also eliminates or reduces the applications specialist's visits to the imaging equipment location to customize the imaging equipment. The invention offers fully automatic customization method driven by the user to adjust the image processing parameters. Further the method is least dependent on the application specialist's skills to translate the user feedback to image processing parameter and also the capability of an expert to provide his views on the images. Thus the method has limited human intervention and hence the method relies less on the expertise of individual in defining the image processing parameters.

Several embodiments are described above with reference to drawings. These drawings illustrate certain details of exemplary embodiments that implement the systems and methods of this disclosure. However, the drawings should not be construed as imposing any limitations associated with features shown in the drawings. Thus various embodiments of the invention describe a computer implemented method and system modifying image processing parameters based on user feedback.

Certain embodiments may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communications protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

While the invention has been described with reference to preferred embodiments, those skilled in the art will appreciate that certain substitutions, alterations and omissions may be made to the embodiments without departing from the spirit of the invention. Accordingly, the foregoing description is meant to be exemplary only, and should not limit the scope of the invention as set forth in the following claims.

We claim:

1. A computer implemented method of modifying image processing parameters based on user feedback, comprising:
obtaining user preferences on a set of displayed images, the set of displayed images processed by a known set of image processing parameters, based on user feedback on a plurality of queries related to at least one domain-specific descriptor and a plurality of corresponding response options indicating a change in at least one image attribute, the plurality of corresponding response options being selectable by a user as user feedback in response to the plurality of queries; and
translating the change in at least one image attribute to modified sets of image processing parameters.

2. The computer implemented method of claim 1, further comprising processing the images using the modified sets of image processing parameters and creating a new set of images for display.

3. The computer implemented method of claim 1, wherein the at least one image attribute includes local and overall contrast, brightness, sharpness, noise, artifacts, etc.

4. The computer implemented method of claim 1, wherein the at least one domain-specific descriptor includes anatomical and/or functional attributes in a medical image.

5. The computer implemented method of claim 1, wherein the at least one domain-specific descriptor is a non-image attribute that is translated into an image attribute using domain specific knowledge.

6. A computer implemented method of modifying image processing parameters of an imaging system, comprising:
presenting a user with at least one processed image for review, wherein the at least one processed image is processed with a set of known image processing parameters;
providing the user with a plurality of questions to solicit user feedback on domain-specific descriptors of at least one processed image;
obtaining user feedback through a plurality of responses from the user to the plurality of questions;
automatically translating the user feedback on domain-specific descriptors to changes in at least one image attribute;
converting changes in at least one image attribute to at least one new set of image processing parameters; and
processing the at least one processed image using at least one new set of image processing parameters.

7. The computer implemented method of claim 6, wherein the step of translating the user feedback on domain-specific descriptors to changes in at least one image attribute involves the use of a rule based technique.

8. The computer implemented method of claim 6, wherein the step of converting changes in at least one image attribute to at least one new set of image processing parameters further includes using a rule based technique to determine a direction of change in a value of the at least one image processing parameter.

9. The computer implemented method of claim 8, wherein the step of converting changes in at least one image attribute to at least one new set of image processing parameters further includes using a rule based technique to determine an amount of change in the value of the at least one image processing parameter.

10. The computer implemented method of claim 6, wherein each question has a plurality of domain-specific descriptors options corresponding to at least one image attribute.

11. The computer implemented method of claim 10, wherein each image attribute change corresponds to a direction of change in a value at least one image processing parameter.

12. The computer implemented method of claim 10, wherein each image attribute change corresponds to an amount of change in a value of at least one image processing parameter.

13. The computer implemented method of claim 12, wherein any changes in direction or amount of an image attribute is translated into at least one new set of image processing parameters.

14. The computer implemented method of claim 13, wherein the step of converting image attribute changes to a new set of image processing parameters further includes processing the direction of change and the amount of change for each image processing parameter value to determine a cumulative change in each image processing parameter value.

15. A computer implemented method for image processing, comprising:
(a) selecting at least one image from an image processing server connected to a database using an interface;
(b) processing the at least one image using an initial set of image processing parameters on the image processing server;
(c) presenting the at least one processed image on a remote display for review by a user;
(d) obtaining real-time feedback on the reviewed at least one processed image from the user using the interface;
(e) modifying the image processing parameters in real-time based on the user's real-time feedback;
(f) re-processing the at least one image using the modified set of image processing parameters to obtain at least one modified image;
(g) reviewing the at least one modified image on the remote display; and
(h) repeating steps (d), (e), (f) and (g) until the user is satisfied with the at least one modified image.

16. The computer implemented method of claim 15, wherein the step of modifying the image processing parameters in real-time is accomplished manually by the user manipulating the plurality of image processing parameters using the interface.

17. The computer implemented method of claim 15, wherein the step of modifying the image processing parameters in real-time is accomplished automatically.

18. The computer implemented method of claim 15, further comprising:
(a) presenting a set of processed images, processed with known image processing parameters;
(b) collecting user feedback through a series of questions and responses by the user;
(c) computing new image processing parameters based on the user's responses to the series of questions; and
(d) updating the known image processing parameters with modified image processing parameters.

19. The computer implemented method of claim 15, wherein the interface is a remote device.

20. The computer implemented method of claim 18, wherein the step of computing new image processing parameters based on the user's responses to the series of questions includes using a rule based technique to determine at least one image processing parameter to change.

21. The computer implemented method of claim 20, wherein the step of computing new image processing parameters based on the user's responses to the series of questions further includes using a rule based technique to determine a direction of change in a value of the at least one image processing parameter.

22. The computer implemented method of claim 21, wherein the step of computing new image processing parameters based on the user's responses to the series of questions further includes processing the direction of change and the amount of change for each image processing parameter value to determine a cumulative change in each image processing parameter value.

23. A computer implemented image processing system, comprising:
a display for presenting at least one image to a user for review;
a feedback system operably coupled to the display for providing the user with a plurality of queries relating to at least one domain-specific descriptor and a plurality of corresponding response options relating to a change in at least one image attribute;
a translator coupled to the feedback system for converting the change in at least one image attribute to modified sets of image processing parameters; and
an image processor configured for processing the at least one image with the new set of image processing parameters.

24. The computer implemented image processing system of claim 23, wherein the display is a remote display.

25. A computer-readable medium having computer executable instructions stored thereon for execution by a processor for performing a method, comprising:
(a) selecting at least one image from an image processing server connected to a database using an interface;
(b) processing the at least one image using an initial set of image processing parameters on the image processing server;
(c) presenting the at least one processed image on a remote display for review by a user;
(d) obtaining real-time feedback on the reviewed at least one processed image from the user using the interface;
(e) modifying the image processing parameters in real-time based on the user's real-time feedback;
(f) re-processing the at least one image using the modified set of image processing parameters to obtain at least one modified image;
(g) reviewing the at least one modified image on the remote display; and
(h) repeating steps (d), (e), (f) and (g) until the user is satisfied with the at least one modified image.
